(19) United States
(12) Patent Application Publication
(10) Pub. No.: US 2005/0185256 A1
(43) Pub. Date: Aug. 25, 2005

(54) Broadband light source with direct pumping structure

(76) Inventors: Sang-Ho Kim, Suwon-si (KR); Seong-Taek Hwang, Pyeongtaek-si (KR); Yun-Je Oh, Yongin-si (KR)

Correspondence Address: CHA & REITER, LLC, 210 ROUTE 4 EAST STE 103, PARAMUS, NJ, 07652, US

(21) Appl. No.: 10/888,727

(22) Filed: Jul. 9, 2004

(30) Foreign Application Priority Data
Dec. 17, 2003 (KR) 2003-92365

(51) Int. Cl. H01S 3/00

(52) U.S. Cl. 359/333

(57) ABSTRACT

Disclosed is a broadband light source with a direct pumping structure including: a first gain medium for generating an amplified spontaneous emission; and a first pump light source connected in series to the first gain medium, for outputting a first pump light provided in the first gain medium.

### CLAIM OF PRIORITY

This application claims priority to an application entitled “Broadband light source with direct pumping structure,” filed in the Korean Intellectual Property Office on Dec. 17, 2003 and assigned Serial No. 2003-92365, the contents of which are hereby incorporated by reference.

### BACKGROUND OF THE INVENTION

1. Field of the Invention

The present invention relates to an optical module, and more particularly to a broadband light source.

2. Description of the Related Art

An important consideration in the design and construction wavelength division multiplexing passive optical networks (hereinafter, referred to as WDM-PONs), it is the development of economical broadband light sources. In WDM-PONs, the broadband light source plays an important role in simultaneously accommodating many subscribers together with a wavelength locked fabry-perot laser diode. In addition, in optical communication systems using an erbium doped fiber amplifier (hereinafter, referred to as an EDFA), the broadband light source is inevitably required to measure the optical characteristics in signal wavelength ranges of 1530 nm˜1570 nm and 1570 nm˜1610 nm.

Conventional broadband light sources generally use a white light source using a halogen lamp or an EDFA which outputs an amplified spontaneous emission (hereinafter, referred to as an ASE), and an edge-emitting light emitting diode (hereinafter, referred to as an EELED), a super luminescent diode (hereinafter, referred to as an SLD). However, since the white light source and the EELED have low power, they are not suitable as light sources for a WDM-PON. Further, since the SLD, which has a relatively high power, is slightly inferior to the EDFA in view of power and bandwidth, it is difficult to use the SLD as a broadband light source of the WDM-PON. While the EDFA has been used as a broadband light source, it is not economical in view of its price.

FIG. 1 is a diagram showing a construction of a conventional broadband light source. The broadband light source 100 includes a pump laser diode 120, a wavelength selective coupler (WSC) 130, an erbium doped fiber (EDF) 140, and an isolator (ISO) 150. The wavelength selective coupler 130, the erbium doped fiber 140, and the isolator 150 are connected in series to each other by means of a first optical waveguide 110. The pump laser diode 120 is connected in parallel to the erbium doped fiber 140 by means of a second optical waveguide 115.

The pump laser diode 120 outputs a pump light having a predetermined wavelength. The wavelength selective coupler 130 provides the erbium doped fiber 140 with the pump light. The erbium doped fiber 140 is pumped by the pump light to output an ASE through its both ends. The ASE output forwardly from the erbium doped fiber 140 passes through the isolator 150 and is output to an exterior of the broadband light source 100 through an output terminal of the broadband light source 100. The ASE output rearwardly from the erbium doped fiber 140 passes through the wavelength selective coupler 130 and is input to one end 102 of the broadband light source 100. The ASE then disappears.

In the conventional broadband light source 100, as described above, since the pump light output from the pump laser diode 120 passes through the wavelength selective coupler 130, it suffers from insertion loss in the wavelength selective coupler 130. In addition, in order to prevent the ASE reflected from one end 102 of the broadband light source 100 from being input to the wavelength selective coupler 130, an angled connector having a critical angle must be installed at one end 102 of the broadband light source 100, or an additional isolator must be installed between one end 102 and the wavelength selective coupler 130. As should be apparent, these additional elements contribute the manufacturing cost of the conventional broadband light source 100.

### SUMMARY OF THE INVENTION

One aspect of the present invention relates to provide a broadband light source with high power and efficiency, which is suitable for a light source for measuring characteristics of an optical device used in a broadband light source for WDM-PON optical communication or optical communication.

One embodiment of the present is directed to a broadband light source with a direct pumping structure including a first gain medium for generating an amplified spontaneous emission, and a first pump light source connected in series to the first gain medium, for outputting a first pump light provided in the first gain medium.

Another embodiment of the present invention is directed to a broadband light source including a first gain medium disposed on a first optical waveguide and a first pump light source connected in series to the first gain medium. The first gain medium generates a first amplified spontaneous emission in accordance with a first pump light provided by the first pump light source. The source also includes a second gain medium disposed on a second optical waveguide and a second pump light source connected in series to the second gain medium. The second gain medium generates a second amplified spontaneous emission in accordance with a second pump light provided by the second pump light source. The source also includes a wavelength selective coupler for connecting the first optical waveguide to a third optical waveguide, connecting the second optical waveguide to the third optical waveguide, and outputting the first and second amplified spontaneous emissions to the third optical waveguide.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a diagram showing the construction of a conventional broadband light source;

FIG. 2 is a diagram showing the construction of a broadband light source with a direct pumping structure according to a first embodiment of the present invention;

FIG. 3 is a diagram showing the construction of a broadband light source with a direct pumping structure according to a second embodiment of the present invention;

FIG. 4 is a diagram showing the construction of a broadband light source with a direct pumping structure according to a third embodiment of the present invention;

FIG. 5 is a diagram showing the construction of a broadband light source with a direct pumping structure according to a fourth embodiment of the present invention; and

FIG. 6 is a graph showing a comparison between power of the broadband light source shown in FIG. 1 and power of the broadband light source shown in FIG. 2.

### DETAILED DESCRIPTION

Hereinafter, embodiments of the present invention will be described with reference to the accompanying drawings. For the purposes of clarity and simplicity, a detailed description of known functions and configuration incorporated herein will be omitted when it may obscure the subject matter of the present invention.

FIG. 2 is a diagram showing the construction of a broadband light source with a direct pumping structure according to a first embodiment of the present invention. The broadband light source 200 includes a pump laser diode (pump LD) 220 connected in series by means of an optical waveguide 210, a gain medium (GM) 230, and an isolator 240.

The pump laser diode 220 is installed at a one (e.g., left) end of the broadband light source 200 and outputs a pump light having a predetermined wavelength.

The gain medium 230 is connected in series to the pump laser diode 220 and is pumped by the pump light to output an ASE forwardly and rearwardly from the gain medium 230. The ASE output forwardly from the gain medium 230 passes through the isolator 240 and is output to an exterior of the broadband light source 200 through an output terminal 202 of the broadband light source 200. The ASE output rearwardly from the gain medium 230 is input to the pump laser diode 220 and then disappears. The gain medium 230 may include a rare-earth ion doped fiber or a rare-earth ion doped planar waveguide.

The gain medium 230 may generate an ASE having a wavelength range of 1520 nm˜1620 nm when using an erbium doped fiber. It is also noted that the gain medium 230 may generate an ASE having a wavelength range of 1520 nm˜1570 nm, when density inversion in the erbium doped fiber is increased, by shortening the length of the erbium doped fiber or increasing the power of a pump light. In contrast, the gain medium 230 may generate an ASE having a wavelength range of 1570 nm˜1620 nm when the density inversion in the erbium doped fiber is reduced by lengthening the length of the erbium doped fiber. Furthermore, the gain medium 230 may generate an ASE having a wavelength range of 1450 nm˜1510 nm when using a thulium doped fiber (TDF), and may generate an ASE having a wavelength range of 1270 nm˜1330 nm when using a praseodymium doped fiber (PDF). In order to obtain an ASE having a desired wavelength, a gain medium capable of obtaining a high gain spectrum in a corresponding wavelength range and a pump light source capable of exciting the gain medium are used. In this way, a wavelength range of the broadband light source 200 is not limited to a specific wavelength range, but may include various wavelength ranges.

The isolator 240 is disposed between the gain medium 230 and the output terminal 202 of the broadband light source 200. It passes the ASE input from the gain medium 230, and blocks light progressing in a direction reverse to an input direction of the ASE.

In an embodiment in which the pump laser diode 220 is a fabry-perot laser diode and when a wavelength range of the ASE generated by the gain medium 230 belongs to a wavelength range of a gain spectrum of the pump laser diode 220, the ASE input to the pump laser diode 220 is resonated on the inside of the pump laser diode 220 and may be then output. The ASE output from the pump laser diode 220 is amplified by the gain medium 230 and may be shown as a ripple on an entire ASE output spectrum of the broadband light source 200. Further, if the power of the ASE input to the pump laser diode 220 is large, the interior of the pump laser diode 220 may be damaged. When a fabry-perot laser diode having a wavelength range of 980 nm generally used as the pump laser diode 220 is used and the erbium doped fiber is used as the gain medium 230, a large difference exists between an output wavelength (980 nm band) of the pump laser diode 220 and a wavelength range (1550 nm band) of the ASE generated by the gain medium 230. Further, since an optical waveguide in the pump laser diode 220 has a core size relatively smaller than that of the optical waveguide 210, ASE mostly disappears before it is input to a resonator in the pump laser diode 220. In this regard, large problem does not occur. However, when a fabry-perot laser diode having a wavelength range of 1480 nm is used as the pump laser diode 220, an additional isolator may be provided between the pump laser diode 220 and the gain medium 230 in order to prevent a ripple from occurring. Currently, in manufacturing the fabry-perot laser diode having the wavelength range of 1480 nm, an isolator is provided at its output side and may be packaged. In this case, a separate isolator is not required.

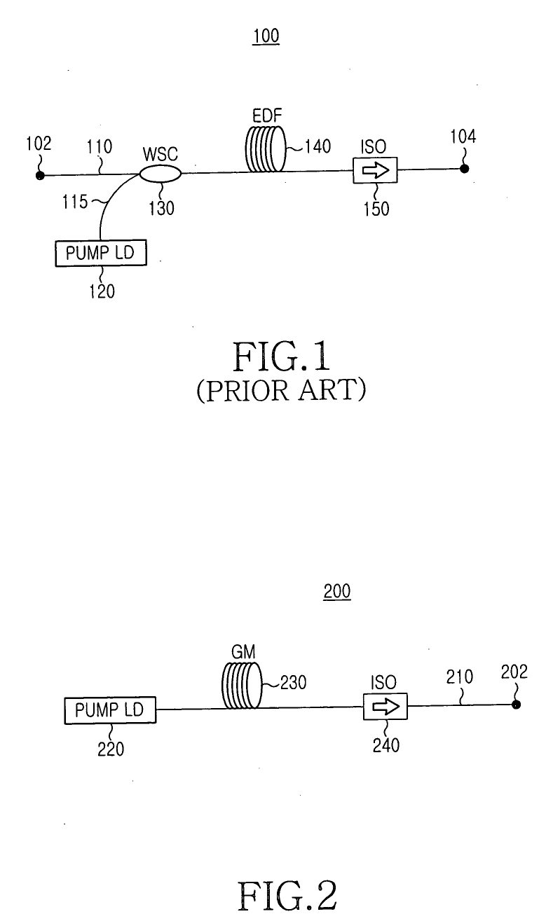

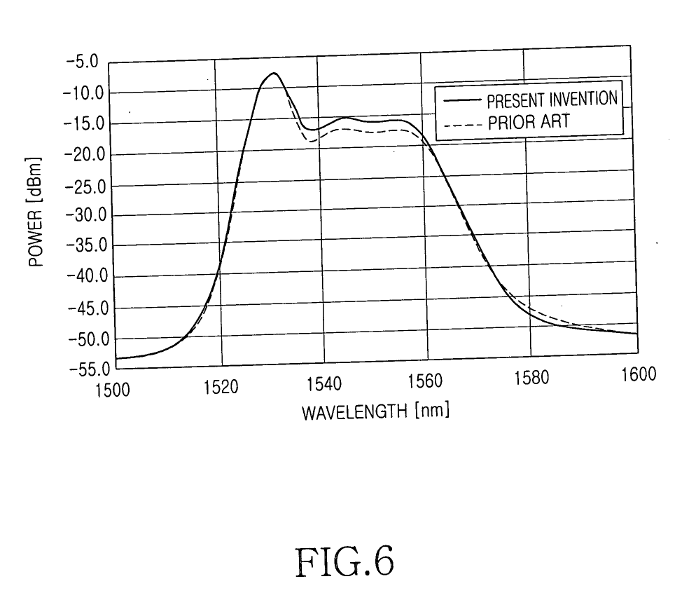

FIG. 6 is a graph showing a comparison between power of the broadband light source shown in FIG. 1 and power of the broadband light source shown in FIG. 2. The two broadband light sources have used erbium doped fibers having the lengths equal to each other and pump laser diodes of 980 nm. The broadband light source according to the first embodiment of the present invention has power level improved by about an average of 2 dB in a wavelength range of 1537 nm˜1560 nm, in comparison with the power level of the conventional broadband light source.

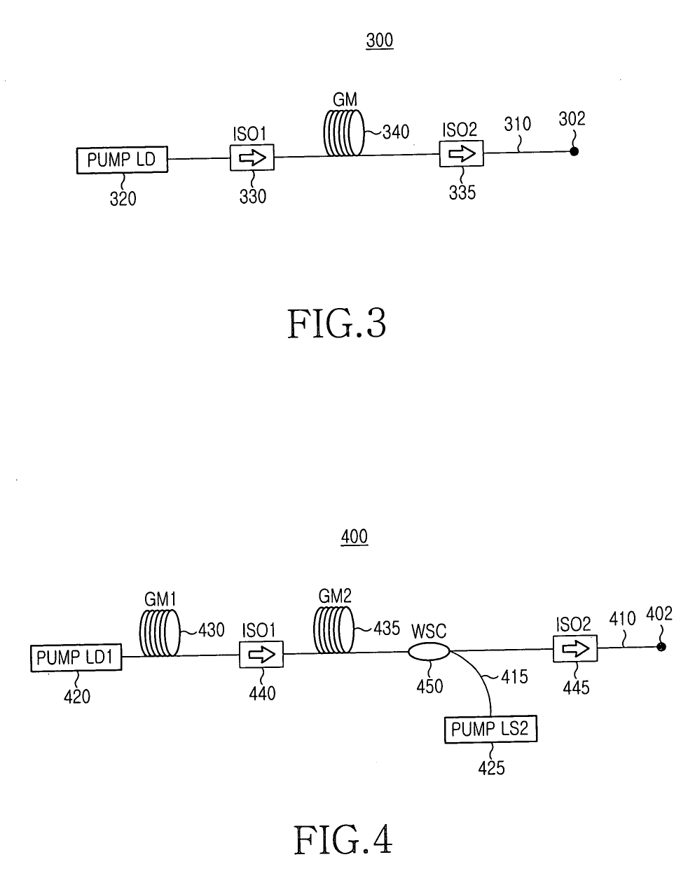

FIG. 3 is a diagram showing the construction of a broadband light source with a direct pumping structure according to a second embodiment of the present invention. The broadband light source 300 includes a pump laser diode 320 connected in series by means of an optical waveguide 310, a first isolator 330, a gain medium 340, and a second isolator 335.

The pump laser diode 320 is installed at one end of the broadband light source 300 and outputs a pump light having a predetermined wavelength.

The first isolator 330 is disposed between the pump laser diode 320 and the gain medium 340. It passes the pump light input from the pump laser diode 320 and blocks light progressing in a direction reverse to an input direction of the pump light.

The gain medium 340 is disposed between the first isolator 330 and the second isolator 335, and is pumped by the pump light to output an ASE forwardly and rearwardly from the gain medium 340. The ASE output forwardly from the gain medium 340 passes through the second isolator 335 and is output to an exterior of the broadband light source 300 through an output terminal 302 of the broadband light source 300. The ASE output rearwardly from the gain medium 340 is input to the first isolator 330 and then disappears.

The second isolator 335 is disposed between the gain medium 340 and the output terminal 302 of the broadband light source 300. It passes the ASE input from the gain medium 340, and blocks light progressing in a direction reverse to an input direction of the ASE.

FIG. 4 is a diagram showing the construction of a broadband light source with a direct pumping structure according to a third embodiment of the present invention. The broadband light source 400 includes a first gain medium 430, a second gain medium 435, a first isolator 440, a second isolator 445, a first pump laser diode 420, a second pump laser diode 425, and a wavelength selective coupler 450. The first gain medium 430, the second gain medium 435, the first isolator 440, the second isolator 445, the first pump laser diode 420, and the wavelength selective coupler 450 are connected in series to each other by means of a first optical waveguide 410. The second pump laser diode 425 is connected in parallel to the second gain medium 435 by means of a second optical waveguide 415.

The first pump laser diode 420 is installed at one end of the broadband light source 400 and outputs a first pump light having a predetermined wavelength.

The first gain medium 430 is disposed between the first pump laser diode 420 and the first isolator 440, and is pumped by the first pump light to output an ASE forwardly and rearwardly from of the first gain medium 430. The ASE output forwardly from the first gain medium 430 passes through the first isolator 440, is input to the second gain medium 435, and is amplified by the second gain medium 435. The ASE then passes through the wavelength selective coupler 450 and the second isolator 445 and is output to an exterior of the broadband light source 400 through an output terminal 402 of the broadband light source 400. The ASE output rearwardly from the first gain medium 430 is input to the first pump laser diode 420 and then disappears.

The first isolator 440 is disposed between the first gain medium 430 and the second gain medium 435. It passes the first pump light input from the first pump laser diode 420, and blocks light progressing in a direction reverse to an input direction of the first pump light.

The second pump laser diode 425 outputs a second pump light having a predetermined wavelength.

The wavelength selective coupler 450 is disposed between the second gain medium 435 and the second isolator 445 and provides the second gain medium 435 with the second pump light.

The second gain medium 435 is disposed between the first isolator 440 and the wavelength selective coupler 450, and is pumped by the second pump light to amplify the input ASE, which will be output.

The second isolator 445 is disposed between the wavelength selective coupler 450 and the output terminal 402 of the broadband light source 400. It passes the ASE input from the first gain medium 430, and blocks light progressing in a direction reverse to an input direction of the ASE.

When erbium doped fibers having lengths different from each other are uses as the first gain medium 430 and the second gain medium 435, ASEs in a C-band (1530 nm˜1570 nm) and an L-band (1570 nm˜1610 nm) may be simultaneously obtained.

For instance, when the first gain medium 430 has a length of 50 m and the second gain medium 435 has a length of 10 m, the first gain medium 430 generates an L-band ASE, and the second gain medium 435 amplifies the L-band ASE and simultaneously generates an C-band ASE

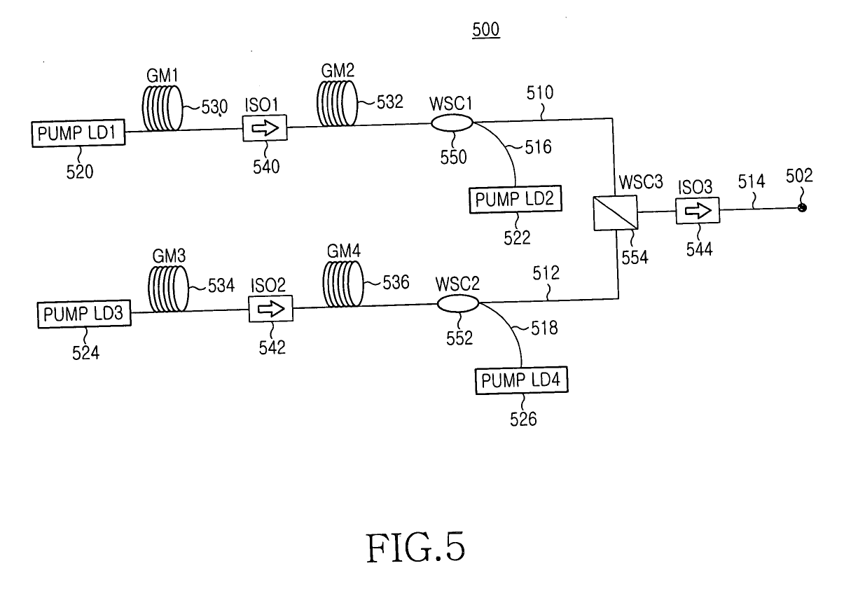

FIG. 5 is a diagram showing the construction of a broadband light source with a direct pumping structure according to a fourth embodiment of the present invention. The broadband light source 500 includes a first to a fifth optical waveguide 510, 512, 514, 516, and 518, a first to a fourth pump laser diode 520, 522, 524, and 526, a first to a fourth gain medium 530, 532, 534, and 536, a first to a third isolator 540, 542, and 544, and a first to a third wavelength selective coupler 550, 552, and 554.

The first pump laser diode 520, the first and the second gain medium 530 and 532, the first isolator 540, and the first wavelength selective coupler 550 are connected in series to each other by means of the first optical waveguide 510. The second pump laser diode 522 is connected in parallel to the second gain medium 532 by means of the fourth optical waveguide 516.

The first pump laser diode 520 is installed at a first end of the broadband light source 500 and outputs a first pump light having a predetermined wavelength.

The first gain medium 530 is disposed between the first pump laser diode 520 and the first isolator 540, and is pumped by the first pump light to output a first ASE forwardly and rearwardly from of the first gain medium 530. The first ASE output forwardly from the first gain medium 530 passes through the first isolator 540, is input to the second gain medium 532, and is amplified by the second gain medium 532. The first ASE then passes through the first wavelength selective coupler 550 and is input to the third wavelength selective coupler 554. The first ASE output rearwardly from the first gain medium 530 is input to the first pump laser diode 520 and then disappears.

The first isolator 540 is disposed between the first gain medium 530 and the second gain medium 532. It passes the first ASE input from the first gain medium 530, and blocks light progressing in a direction reverse to an input direction of the first ASE.

The second pump laser diode 522 outputs a second pump light having a predetermined wavelength.

The first wavelength selective coupler 550 is disposed between the second gain medium 532 and the third wavelength selective coupler 554, and provides the second gain medium 532 with the second pump light.

The second gain medium 532 is disposed between the first isolator 540 and the first wavelength selective coupler 550, and is pumped by the second pump light to amplify the first ASE to be output. The first ASE then passes through the first wavelength selective coupler 550 and is input to the third wavelength selective coupler 554.

The third pump laser diode 524, the third and the fourth gain medium 534 and 536, the second isolator 542, and the second wavelength selective coupler 552 are connected in series to each other by means of the second optical waveguide 512. The fourth pump laser diode 526 is connected in parallel to the fourth gain medium 536 by means of the fifth optical waveguide 518.

The third pump laser diode 524 is installed at a second end of the broadband light source 500 and outputs a third pump light having a predetermined wavelength.

The third gain medium 534 is disposed between the third pump laser diode 524 and the second isolator 542, and is pumped by the third pump light to output a second ASE forwardly and rearwardly from of the third gain medium 534. The second ASE output forwardly from the third gain medium 534 passes through the second isolator 542, is input to the fourth gain medium 536, and is amplified by the fourth gain medium 536. The second ASE then passes through the second wavelength selective coupler 552 and is input to the third wavelength selective coupler 554. The second ASE output rearwardly from the third gain medium 534 is input to the third pump laser diode 524 and then disappears.

The second isolator 542 is disposed between the third gain medium 534 and the fourth gain medium 536. It passes the second ASE input from the third gain medium 534, and blocks light progressing in a direction reverse to an input direction of the second ASE.

The fourth pump laser diode 526 outputs a fourth pump light having a predetermined wavelength.

The second wavelength selective coupler 552 is disposed between the fourth gain medium 536 and the third wavelength selective coupler 554, and provides the fourth gain medium 536 with the second pump light.

The fourth gain medium 536 is disposed between the second isolator 542 and the third wavelength selective coupler 554, and is pumped by the fourth pump light to amplify the input second ASE to be output. The second ASE then passes through the second wavelength selective coupler 552 and is input to the third wavelength selective coupler 554.

The third wavelength selective coupler 554 connects the first optical waveguide 510 to the third optical waveguide 514, and connects the second optical waveguide 512 to the third optical waveguide 514. The third wavelength selective coupler 554 outputs the input first and second ASEs to the third optical waveguide 514.

The third isolator 544 is installed on the third optical waveguide 514 in order to be disposed between the third wavelength selective coupler 554 and an output terminal 502 of the broadband light source 500. Further, the third isolator 544 passes the input first and second ASEs and blocks light progressing in a direction reverse to an input direction of the first and the second ASE. The first and the second ASE passing through the third isolator 544 is output to an exterior of the broadband light source 500 through the output terminal 502 of the broadband light source 500.

As described above in relation to the first embodiment, a broadband light source with a direct pumping structure can obtain improved power output by connecting a pump laser diode to a gain medium in series. In addition, such a broadband light source can be more economically manufactured by reducing the number of optical devices.

It will also be appreciated that broadband light sources contribute to a major portion of the total cost of a WDM-PON system using a wavelength locked fabry-perot laser diode. Therefore, when a broadband light source employs a basic structure or an applied structure according to various embodiments of the present invention, the broadband light source enables construction of an economic optical subscriber network.

While the invention has been shown and described with reference to certain embodiments thereof, it will be understood by those skilled in the art that various changes in form and details may be made therein without departing from the spirit and scope of the invention as defined by the appended claims.

1. A broadband light source comprising:
a gain medium; and
a pump light source connected in series to the gain medium,
wherein the gain medium generates an amplified spontaneous emission in accordance with a pump light provided by the pump light source.

2. The broadband light source as claimed in claim 1, further comprising an isolator disposed between the gain medium and an output terminal of the broadband light source, for passing the amplified spontaneous emission input from the gain medium, and for blocking light progressing in a direction reverse to an input direction of the amplified spontaneous emission.

3. The broadband light source as claimed in claim 1, further comprising an isolator disposed between the pump light source and the gain medium, for passing the pump light input from the pump light source, and for blocking light progressing in a direction reverse to an input direction of the pump light.

4. A broadband light source comprising:
a first gain medium;
a first pump light source connected in series to the first gain medium, where the first gain medium generates an amplified spontaneous emission in accordance with a first pump light from the first pump light source;
a second gain medium connected in series to the first gain medium, for amplifying the amplified spontaneous emission output from the first gain medium;
a second pump light source connected in parallel to the second gain medium, for outputting a second pump light; and
a wavelength selective coupler, connected between the second pump light source and the second gain medium, for providing the second gain medium with the second pump light.

5. The broadband light source as claimed in claim 4, further comprising a first isolator disposed between the first gain medium and the second gain medium, for passing the amplified spontaneous emission input from the first gain medium, and for blocking light progressing in a direction reverse to an input direction of the amplified spontaneous emission.

6. The broadband light source as claimed in claim 4, further comprising a second isolator disposed between the wavelength selective coupler and an output terminal of the broadband light source, for passing the amplified spontaneous emission, and for blocking light progressing in a direction reverse to an input direction of the amplified spontaneous emission.

7. The broadband light source as claimed in claim 5, further comprising a second isolator disposed between the wavelength selective coupler and an output terminal of the broadband light source, for passing the amplified spontaneous emission, and for blocking light progressing in a direction reverse to an input direction of the amplified spontaneous emission.

8. A broadband light source comprising:
a first gain medium disposed on a first optical waveguide;
a first pump light source connected in series to the first gain medium, where the first gain medium generates a first amplified spontaneous emission in accordance with a first pump light provided by the first pump light source;
a second gain medium disposed on a second optical waveguide;
a second pump light source connected in series to the second gain medium, where the second gain medium generates a second amplified spontaneous emission in accordance with a second pump light provided by the second pump light source; and
a first wavelength selective coupler for connecting the first optical waveguide to a third optical waveguide, connecting the second optical waveguide to the third optical waveguide, and outputting the first and second amplified spontaneous emissions to the third optical waveguide.

9. The broadband light source as claimed in claim 8, further comprising:
a third gain medium connected in series to the first gain medium, for amplifying the first amplified spontaneous emission output from the first gain medium;
a third pump light source connected in parallel to the third gain medium, for outputting a third pump light; and
a second wavelength selective coupler for transmitting the third pump light to the third gain medium.

10. The broadband light source as claimed in claim 8, further comprising:
a fourth gain medium connected in series to the second gain medium, for amplifying the second amplified spontaneous emission output from the second gain medium;
a fourth pump light source connected in parallel to the fourth gain medium, for outputting a fourth pump light; and
a third wavelength selective coupler for transmitting the fourth pump light to the fourth gain medium.

11. The broadband light source as claimed in claim 8, further comprising a first isolator disposed between the first gain medium and the third gain medium, for passing the first amplified spontaneous emission input from the first gain medium, and for blocking light progressing in a direction reverse to an input direction of the first amplified spontaneous emission.

12. The broadband light source as claimed in claim 8, further comprising a second isolator disposed between the second gain medium and the fourth gain medium, for passing the second amplified spontaneous emission input from the second gain medium, and for blocking light progressing in a direction reverse to an input direction of the second amplified spontaneous emission.

13. The broadband light source as claimed in claim 11, further comprising a second isolator disposed between the second gain medium and the fourth gain medium, for passing the second amplified spontaneous emission input from the second gain medium, and for blocking light progressing in a direction reverse to an input direction of the second amplified spontaneous emission.

14. The broadband light source as claimed in claim 8, further comprising a third isolator disposed on the third optical waveguide, for passing the first and the second amplified spontaneous emissions, and for blocking light progressing in a direction reverse to an input direction of the first and the second amplified spontaneous emissions.

15. The broadband light source as claimed in claim 13, further comprising a third isolator disposed on the third optical waveguide, for passing the first and the second amplified spontaneous emissions, and for blocking light progressing in a direction reverse to an input direction of the first and the second amplified spontaneous emissions.
